(19) United States
(12) Patent Application Publication
(10) Pub. No.: US 2004/0027378 A1
(43) Pub. Date: Feb. 12, 2004

(54) Creation of user interfaces for multiple devices

(76) Inventors: Grace L. Hays, San Jose, CA (US); Florence Perot, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/213,634

(22) Filed: Aug. 6, 2002

(51) Int. Cl. G09G 5/00

(52) U.S. Cl. 345/763; 345/826

(57) ABSTRACT

A method for designing a user interface may include the steps of selecting at least two target devices or target device categories, designing a user interface, simulating each of said selected target devices or target device categories, validating said user interface on each of said selected target devices or device categories in response to said simulating step, and deploying said user interface to said selected target devices or available device simulators.

### RELATED APPLICATIONS

The present application is related to commonly assigned U.S. patent application Ser. No. [Attorney Docket No. 100200591-1] entitled “SYSTEM FOR AND METHOD OF DEVELOPING A COMMON USER INTERFACE FOR MOBILE APPLICATIONS,” and U.S. patent application Ser. No. [Attorney Docket No. 100200597-1] entitled “USER INTERFACE DESIGN AND VALIDATION INCLUDING DYNAMIC DATA,” filed concurrently herewith, the disclosures of which are hereby incorporated by reference in their entireties.

### FIELD OF THE INVENTION

The present invention relates to designing user interfaces for devices, and more specifically to creating user interfaces for multiple devices.

### BACKGROUND OF THE INVENTION

A User Interface (UI) facilitates data exchange between a user and electronic equipment by formatting output data and accepting input data in a format and manner convenient for the user. Acting as an intermediary between the user and the device, a well-designed UI improves user efficiency and enhances the user's ability to completely utilize the capabilities of the particular device being employed.

Because of the variety of display and input devices used by electronic equipment, it may be necessary to customize the UI for each device. Alternatively, UI developers may attempt to implement a single UI design across a wide range of devices. However, development of a non-device specific user interface may be extremely problematic for UI developers. For example, a small device with a four-line display is not capable of displaying as much user-readable information as is a device with a larger forty-line display. In general, UI development for mobile devices is particularly challenging for designers because of the limited processing and display capabilities compared to stationary and desktop devices.

Therefore, an important parameter for developers of UI applications is the processing capability of the devices running the UI. Developers who design applications for multiple devices may develop a single application based on the device with the most limited capability, or may develop a custom application for each target device. A design based on the most limited device means that the UI is not able to utilize the power or capabilities of more advanced devices. A device-specific UI is better able to fully and efficiently use the processing or display characteristics of a particular electronic device. However, developers often must design and test a UI on each device that will use the UI, a process that is time consuming and non-optimal.

### SUMMARY OF THE INVENTION

An embodiment of the present invention is directed to a method for designing a user interface including the steps of selecting target devices, designing a user interface, simulating each selected target device, validating the user interface on the selected target devices in response to target device simulation, and deploying the user interface to the selected target devices.

### BRIEF DESCRIPTION OF THE DRAWINGS

FIG. 1 is a block diagram of an apparatus for designing a user interface according to an embodiment of the present invention;

FIG. 2 is a flow diagram of the steps included in a method of designing, validating and generating a UI according to an embodiment of the present invention;

FIG. 3 is a flow diagram of a method of generating a UI according to an embodiment of the present invention;

FIG. 4a is a screen shot of a display illustrating one embodiment of the present invention;

FIG. 4b is a screen shot of a display illustrating a non-validated UI in a device simulator;

FIG. 4c is a screen shot of a display illustrating a validated UI in a device simulator; and,

FIG. 5 is a screen shot of a display illustrating a target device selection module according to one embodiment of the present invention.

### DETAILED DESCRIPTION

A User Interface (UI) allows for simplified and sometimes standardized use of electronic equipment. The UI typically provides a graphical approach to electronic equipment control. Given standard data input and output devices, UI designers may design and test a UI with relative ease. However, with the rising popularity of mobile electronic equipment, UI designers are no longer designing to a relatively homogenous collection of devices that have similar display and input facilities. UIs are often customized to match the available capabilities of UI target devices (e.g., Nokia or Ericsson) or device categories (e.g. phone, Personal Digital Assistant (PDA), or screen size).

Problems associated with customizing a UI to each target device include high cost and development time requirements. As a result, designers will simply design a limited UI that will work on all selected UI target devices based on the “lowest common denominator,” or least capable of the target platforms. This approach is not optimal, as it fails to utilize the full capabilities of more advanced devices. A UI customization approach is a desirable alternative, but the current cycle of UI design, followed by deployment and testing, followed by UI re-design, is inefficient and costly. A solution is needed that will provide for efficient UI customization and testing.

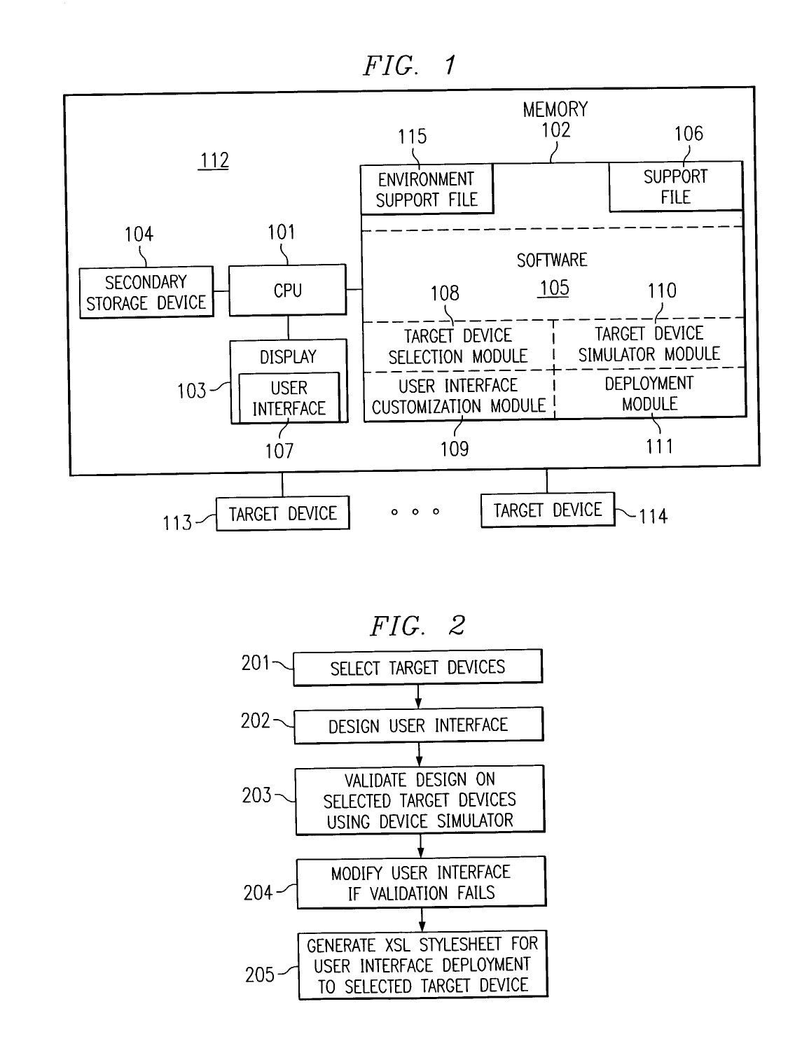

FIG. 1 is a block diagram of an apparatus according to an embodiment of the invention. An apparatus may include Central Processing Unit (CPU) 101, memory 102 connected to CPU 101, display subsystem 103, and secondary storage device 104. Display subsystem 103 and secondary storage device 104 may be connected to CPU 101. Display subsystem 103 may be a CRT display, LCD display, or any such device for communicating with a user. Display subsystem 103 may also display user interface 107 generated by software 105 residing in memory 102 or secondary storage device 104. In a preferred embodiment, software 105 and support file 106 may reside in memory 102. Support file 106 may be support data, data in memory, a supporting data model or similar sources of data. Software 105 may include target device selection module 108, user interface customization module 109, target device simulator module 110, and/or deployment module 111. In other embodiments, the number and type of software modules may vary. UI development system 112 may be connected to target devices 113 and/or 114. Target devices may include, but are not limited to Personal Digital Assistants (PDAs), mobile telephonic devices, electronic devices for playing previously recorded music, laptop computers, global positioning systems, and analytical instruments. Note that FIG. 1 illustrates only one embodiment of the claimed invention and that in other embodiments, the components and modules included may vary. Memory also may include environment support file 115, generated by software 105 to support multiple target devices in specific support environments.

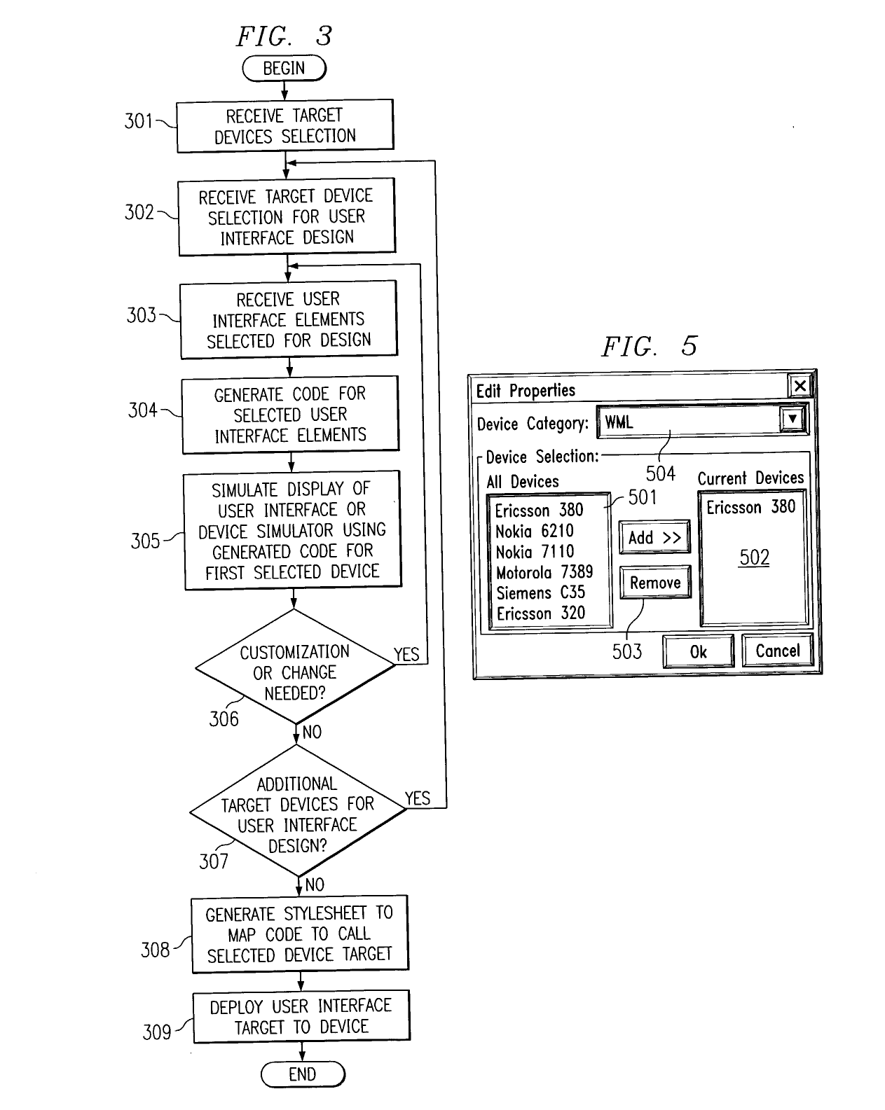

FIG. 2 is a flow diagram of a method according to an exemplary embodiment of the invention. In Step 201, devices on which a UI will be deployed may be selected and added to a list of selected target devices. Selection of devices may be effected in many ways; however, in a preferred embodiment, selection may take place using a computer program module, such as target device selection module 108, implemented using computer hardware and software as in FIG. 1. A preferred embodiment contemplates a point-and-click method of selection, but other methods such as drag-and-drop, direct keyboard input, touch-screen selection or drop-down list for device category selection are also contemplated. The point-and-click selection method contemplated by a preferred embodiment allows a user to select devices from a device selection list. Removal of devices previously selected as a target device, or removal of device categories, for UI implementation may be contemplated by the invention. Removal may be accomplished by any selection methods described above, but may be accomplished in a preferred embodiment using a point-and-click method. A deployment environment may also be selected, such as HP Application Server™. Specific deployment environments may provide support for a variety of target devices using a common UI design that may be customized for each target device variety supported by a deployment environment. A preferred embodiment may include user selectable deployment environments, or may allow a UI to be generated by device category or by specific device.

Once a device or device category is selected for UI deployment, UI design may take place in Step 202. Design of a UI to be deployed may occur using a variety of methods. For example, UI appearance or layout may initially be controlled using mechanical methods, such as hand drawing or drafting methods, or may be controlled using a computer program module such as UI customization module 109 in FIG. 1. Regardless of the method selected for UI design in Step 202, design of a UI may reflect the desired visual appearance of the UI on devices selected for deployment of a UI.

In a preferred embodiment, a desired UI layout appearance may be designed using a computer program module featuring elements selected from a palette or other arrangement. Selectable elements may include, but are not limited to, action elements, input elements, display elements, and specific elements. Action elements may include elements such as buttons, links, server parameters, and/or hidden variables. Input elements may include elements such as text input, radio button group, radio button, menu, menu item, check box group, check box, choice box group, and/or choice box. Display elements may include elements such as image, text output, label, list, list item, table and/or table cell. Specific elements may include elements for use with mark-up languages such as Wireless Markup Language (WML), Compact Hypertext Markup Language (CHTML), Extensible Hypertext Markup Language (XHTML) or Pocket Hypertext Markup Language (Pocket HTML). WML specific elements may include elements such as event, template, timer, variable, and/or WML buttons. CHTML specific elements may include elements such as blink and/or marquee. Note that other selectable elements are contemplated by the invention. A program module may allow placement of selectable elements such that a desired UI layout may be designed. Once a desired UI layout is achieved, a method may contemplate code generation allowing selected target devices to duplicate the appearance of a UI. In a preferred embodiment, the generated code may be a mark-up language such as WML, CHTML or other HTML-based markup languages. Note that in alternative embodiments, a UI design may be generated directly using a language such as WML, CHTML, XHTML, Pocket HTML or other HTML-based markup languages, or by using methods not employing a selectable element module.

A preferred embodiment of the invention may incorporate a deck-and-card UI design. In this UI design, a series of separate information compartments may be generated and stored in memory 102 (FIG. 1) or secondary storage device 104 (FIG. 1). Each of the compartments is known as a card; a collection of such cards is known as a deck. For example, one UI may contain a collection of book titles with short descriptions. Each title and accompanying description would be considered a card, while the entire book collection would be considered a deck. The deck-and-card UI design represents a potential method for presenting data, but is only one of many such organizational methods contemplated by the invention. Another organizational method contemplated is the use of pages.

In Step 203, a UI design may be validated on deployment devices selected in Step 201. In one embodiment, a UI design may be validated if a deployment device on which a UI will be deployed is able to duplicate the desired appearance of a UI, given appropriate instructions. A UI may be validated using target device simulator module 110 as shown in FIG. 1. The device simulator may be embedded, integrated or external. A target device simulator module may comprise parameter sets for target device selections available to a user. In a preferred embodiment, target device selection parameters may be available for, but are not limited to, various mobile telephonic devices. Parameter information may include data such as display size, memory capacity, processor capabilities, display color information, protocols supported, and input/output capabilities of target devices. Target devices or target device categories other than mobile telephonic devices may be contemplated by a preferred embodiment of the method and include Personal Digital Assistants (PDAs), electronic devices for playing previously recorded music, laptop computers, global positioning systems, and analytical instruments.

Step 204 may be employed if validation of a UI fails in Step 203. If UI validation indicates that a UI design must be customized to duplicate the desired appearance on a selected device, then a UI may be customized. Customization may be global, as when a UI validation indicates that a UI does not produce a desired appearance on all selected target devices, or local, as when the UI does not produce the desired appearance on only some selected target devices. In a preferred embodiment, customization of a UI may take place using UI customization module 109 described in FIG. 1. In Step 204, a preferred embodiment also may contemplate the removal of devices or device categories from a list of selected devices or device categories generated in Step 201.

Customization of a UI design may be device or device category specific. For example, if a UI design produces a validated UI of the desired appearance on one selected target device, but not on another, UI design may be customized for a device on which the UI was not validated. If a UI uses a deck-and-card organizational system, a preferred embodiment may include customization of selected cards or selected decks. In other embodiments, the organizational system may include pages, and the embodiment may customize selected pages. Support file 106 may track customizations made to a UI design, either as a global customization that affects a UI design on all selected target devices or device categories, or as a local customization affecting only a subset of selected target devices or device categories. Support file 106 also may track changes made to specific cards in a card-and-deck UI arrangement, as well as more general changes made to entire decks or specific pages.

In Step 205, a UI design may be deployed to target devices selected in Step 201. A UI design may also be deployed to other device simulators if customization of the UI is done for specific device categories. Deployment of a UI may involve generating specific control language that will enable a selected target device to render the desired appearance of a UI. A preferred embodiment of the method may include the generation or use of Extensible Stylesheet Language (XSL) stylesheets by deployment module 111. In one embodiment, an XSL stylesheet is a file that describes to a selected target device how to display UI information, which is typically specified in a WML file. An XSL stylesheet may be used to map, or translate, UI content specified in a WML file. However, other methods of controlling the content of a UI may also or alternatively be implemented, such as by XML, CHTML or other HTML-based languages, and other methods for controlling the display of a UI, such as by Wireless Application Protocol (WAP) or iMode protocols.

In one embodiment, if a user has selected a deployment environment in Step 201, deployment step 205 also may generate environment support file 115, shown in FIG. 1, that may be used by a deployment environment to customize a UI design to each supported target device. In a preferred embodiment, a generated support file 106 may contain information that maps each customized UI to each target device supported by a deployment environment. In a preferred embodiment, deployment environments such as HP Application Server™, HP Total-e-Mobile™, Cocoon™, and open-source servers may be contemplated.

Support file 106 data generated in Step 204 may be used to control deployment of a UI design. Support file 106 data may be used to modify the generation of XSL stylesheets so that UI customization changes in Step 204 may be incorporated into a UI design before the UI is deployed to target devices.

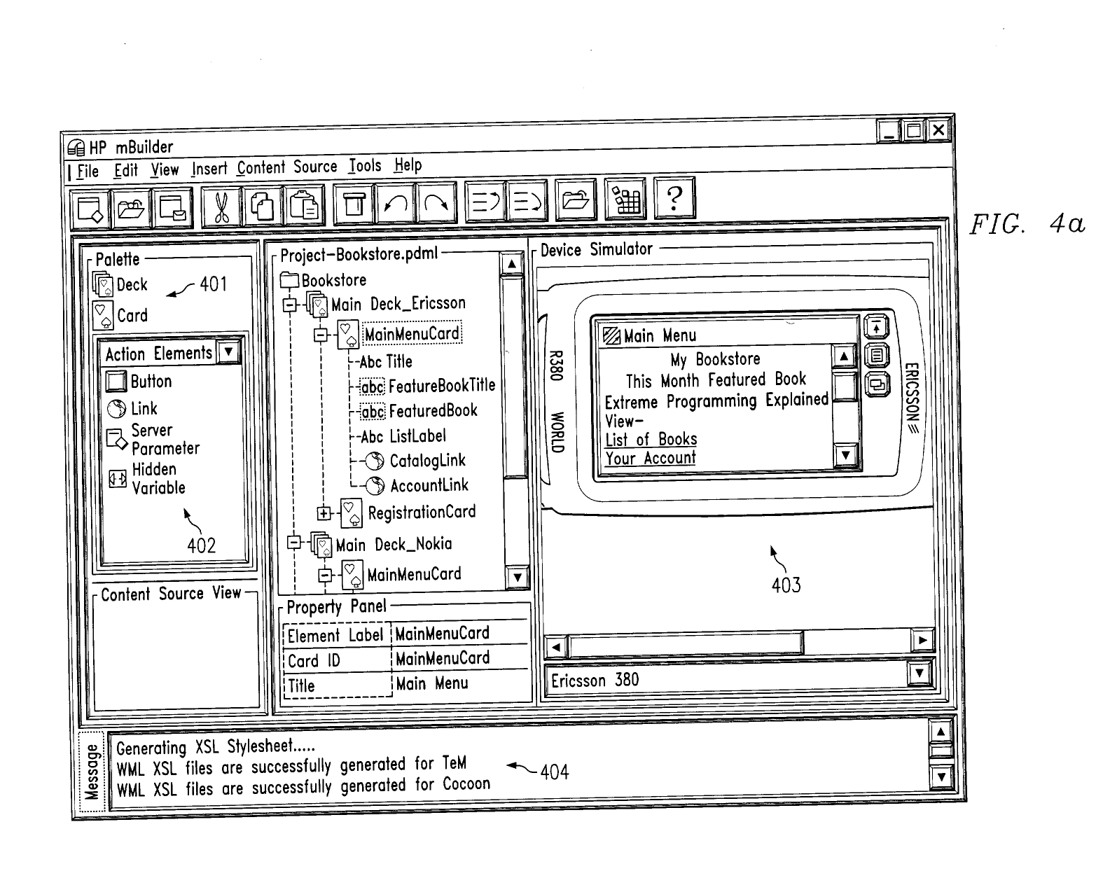

FIG. 3 is a flow diagram illustrating a computer program product in a preferred embodiment of the invention. In Step 301, a program may receive user selection of target devices or device categories. A point-and-click selection method employing a selection list, as described in FIG. 1, may be used in a preferred embodiment. Alternatively, a drop-down list of the device categories (e.g., phone, PDA or screen size) may be used. In Step 302, a computer program may receive user selection of a target device or device category for UI design. In a preferred embodiment, the target device selection may be made from the target devices or device categories selected in Step 301. In Step 303, a computer program may receive UI elements selected by a user for incorporation in a UI design. A drag-and-drop selection method is used for UI element selection in a preferred embodiment of the invention.

Step 303 may allow for the selection of UI elements including, but not limited to, such elements as action elements, input elements, display elements, and specific elements. Action elements may include elements such as buttons, links, server parameters, and/or hidden variables. Input elements may include elements such as text input, radio button group, radio button, menu, menu item, check box group, check box, choice box group, and/or choice box. Display elements may include elements such as image, text output, label, list, list item, table and/or table cell. Specific elements may include elements for use with mark-up languages such as WML, CHTML, XHTML or Pocket HTML. WML specific elements may include elements such as event, template, timer, variable, and/or WML buttons. CHTML specific elements may include elements such as blink and/or marquee. Note that other selectable elements are contemplated by the invention.

In Step 304, a program may generate code for each selected UI element. Code generation may take place after all elements comprising a UI are selected in Step 303, or may take place as each individual element is selected. In a preferred embodiment, code may be generated in Step 304 as each UI element is selected by a user in Step 303. The code generated by a program may use a variety of languages, such as CHTML, WML, XHTML and Pocket HTML mark-up languages used in a preferred embodiment.

In Step 305, generated code may be used by a program to simulate the display of a UI by each target device selected in Step 301. In Steps 304 and 305, the generated code may be used by a program to simulate the display of a UI by other target devices selected in Step 301. In Step 306, a test may be performed to determine if additional customization or change is needed for the UI displayed in Step 305. If so, a program routine may branch to Step 303 to allow additional customization. If no changes are needed, a program may go on to Step 307. In Step 307, a test may be performed to determine if there are additional target devices for UI design. If so, the routine may branch to Step 302 to allow selection of additional target devices for UI design. If not, the routine may go on to Step 308.

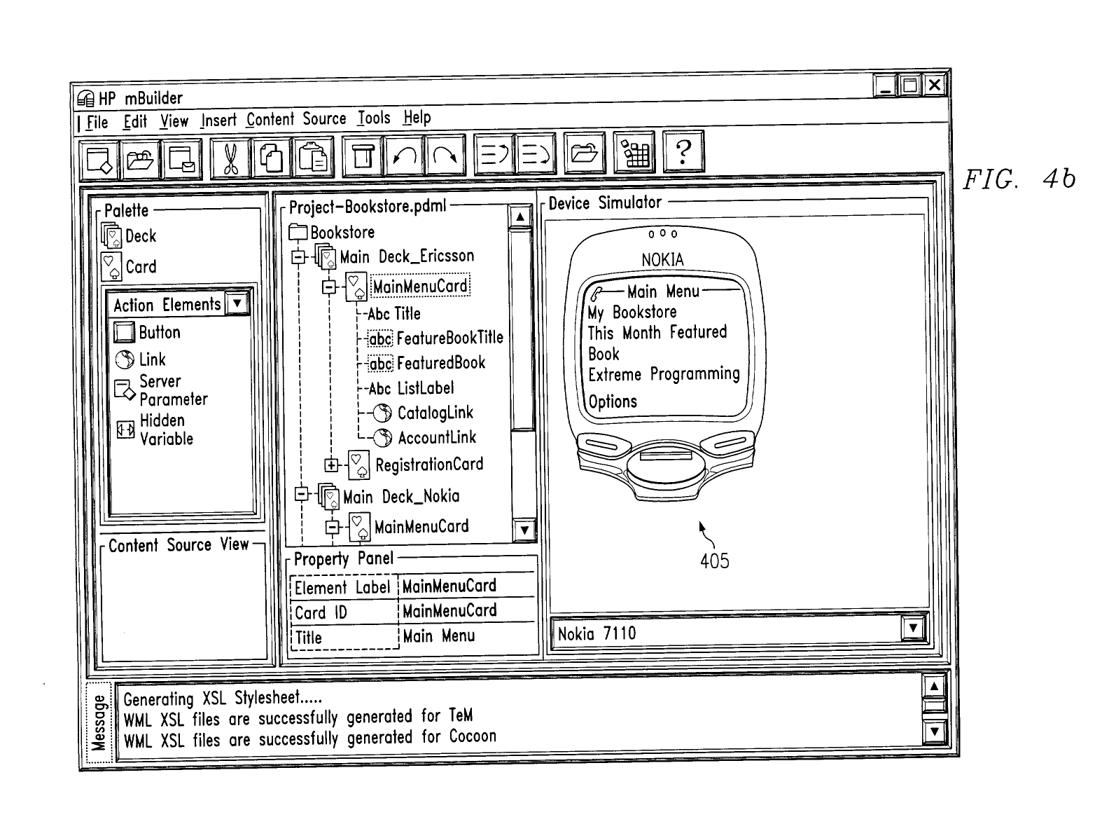

A preferred embodiment may have a device simulator module such as the module illustrated in FIGS. 1 and 4. The device simulator may be an embedded simulator, an integrated simulator or an external simulator. Each UI display may be validated by a user to determine if a UI in the device simulator reflects a desired UI design. If changes to a UI are required by a user, a program may enable a user to modify UI elements to correctly display a UI on each device using tools available in Step 303. Changes may be made globally, so all selected devices are affected, or changes may be made to individual selected target devices.

In Step 308, a program may generate stylesheets for each device selected in Step 301. Stylesheets may contain information enabling a UI to display correctly on target devices. The stylesheets may use the XSL language to control mapping of the mark-up language code generated in Step 304. In Step 309, stylesheets may be provided to a server, and a stylesheet engine on a server may generate a UI, which may be deployed to target devices.

FIG. 4a is a screen shot of a display generated by a UI development tool according to an embodiment of the invention. The display may include deck-and-card organization component 401, UI design component 402, device simulator component 403, and deployment component 404. Deck-and-card organization component 401 and UI design component 402 may enable design and customization of a UI. Device simulator 403 may be configured to display selected target devices, and may be used to effect UI validation in Step 203. The device simulator may be an embedded simulator, an integrated simulator or an external simulator. Deployment component 404 may monitor the deployment process of Step 205. FIG. 4a shows a successfully validated UI, in one embodiment, in device simulator 403, containing information that may be required to be displayed in a UI by a designer. FIG. 4b shows a UI in the display simulator, in one embodiment, that is not validated. UI information is truncated because the smaller screen of target device simulator 405 will not allow display of sufficient information. FIG. 4c shows a target device simulator in one embodiment with correctly configured UI 406 after customization. In one embodiment, a user may have eliminated extraneous text, leaving only necessary functional information, that in this screen shot comprises text selectable to retrieve a list of books or account information. It will be understood that organizational component 401 may also include pages.

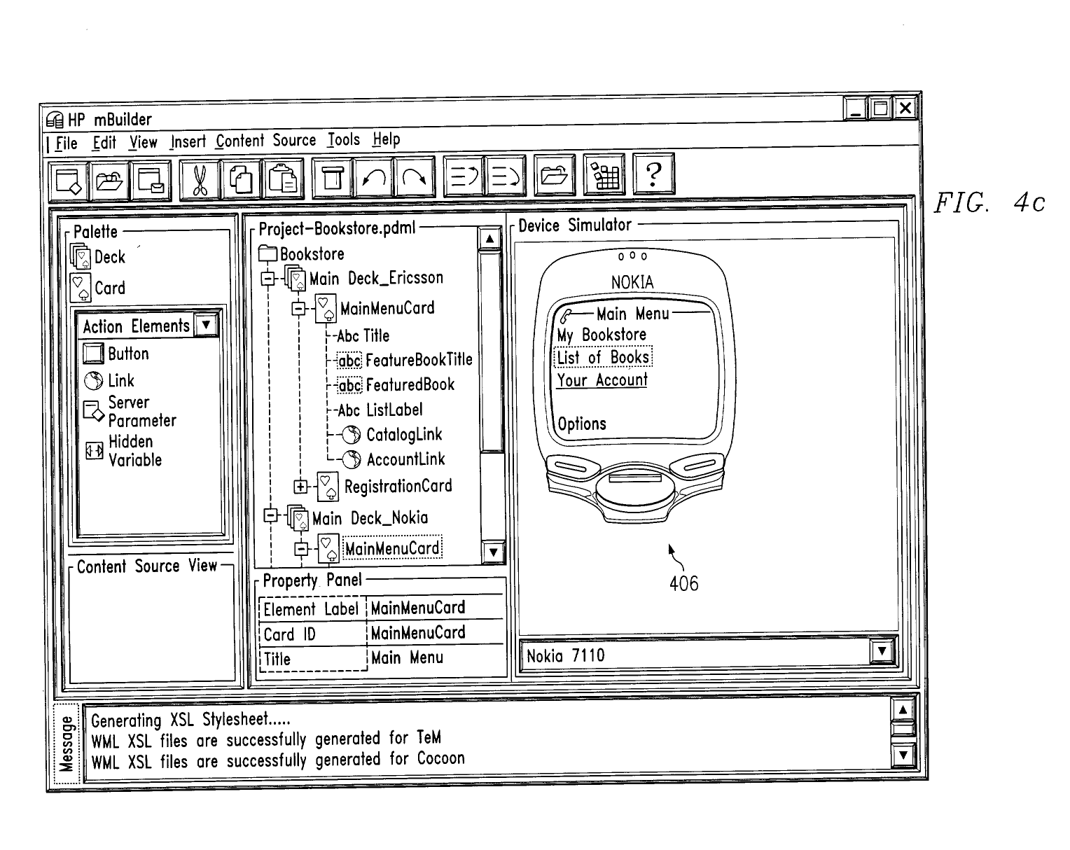

FIG. 5 is a display illustration of target device selection module 108 in one embodiment. The device selection module may comprise a list of selectable target devices 501 in one window of a module, and a list of selected target devices 502 in a second window of a module. Devices may be added to or removed from a list of selected target devices using a drag-and-drop selection method or using radio buttons 503. A target device selection module may include the ability to select devices based on target device control language. Device category selector 504 may show WML devices by default, but may include a variety of other control language environments in other embodiments.

What is claimed is:

1. A method for designing a user interface comprising:
selecting at least two targets;
designing a user interface;
simulating each of said selected targets;
validating said user interface on each of said selected targets or on an available device simulator using said simulating step.

2. The method of claim 1 wherein said targets are target devices or target device categories or both.

3. The method of claim 1 further comprising:
deploying said user interface to said selected target.

4. The method of claim 1 wherein the steps are programmed steps implemented using computer hardware and software.

5. The method of claim 1 further comprising:
customizing said user interface for each target if not successfully validated in said validation step.

6. The method of claim 5 wherein said customization step includes removal of at least one target selected in said step of selecting at least two targets.

7. The method of claim 2 wherein said customization includes the specification of an additional device type or an additional device category.

8. The method of claim 5 wherein said customization step includes generation of a supporting file to track changes to said user interface.

9. The method of claim 3 wherein said deploying step further comprises:
mapping XSL stylesheets generated by said deploying step to said selected target devices.

10. The method of claim 3 wherein said deploying step generates XSL stylesheets for deploying said user interface to said selected target devices.

11. An apparatus comprised of a computing device having at least one central processing unit and a memory coupled to said central processing unit, said computing device enabling the customization of a user interface when said computing device employs a computer application configured to allow:
target selection;
user interface customization;
target simulation; and
user interface deployment.

12. The apparatus of claim 11 wherein said target is selected from the group consisting of target devices and target categories.

13. The apparatus of claim 11 wherein said user interface deployment generates XSL stylesheets.

14. The apparatus of claim 11 wherein said user interface customization includes the customization of card and deck projects.

15. The apparatus of claim 13 wherein changes to user interface during user interface customization are recorded using a supporting file, and said supporting file is used during user interface deployment to map said XSL stylesheets to specific targets.

16. The apparatus of claim 11 wherein said target selection includes the addition or deletion of target selections globally at the project level and locally at the deck level.

17. The apparatus of claim 11 wherein said target selection includes the addition or deletion of target selections globally at deck level and locally at the card level.

18. The apparatus of claim 11 wherein said target selection includes the addition or deletion of a deployment environment.

19. A computer program product comprising computer-readable code stored on computer-readable medium, said computer program comprising:
computer readable program code for receiving target device selection;
computer readable program code for receiving user interface element selection;
computer readable program code for generating code from selected user interface elements;
computer readable program code for simulating display of generated code on selected target devices; and
computer readable program code for generating stylesheets.

20. The computer program product of claim 19 further comprising:
computer readable program code for deploying user interface to selected target devices.

21. The computer program product of claim 19 wherein said user interface generation computer readable program code further includes deck-and-card page generation computer readable program code.

22. The computer program product of claim 19 wherein said simulating display computer readable program code is further configured for simulating user interface display on mobile device displays.

23. The computer program product of claim 19 wherein said user interface element selection computer readable program code and said code generation computer readable program code further comprise a computer readable program code for tracking changes to said user interface.

24. The computer program product of claim 23 wherein said computer readable program code for tracking changes is used by said computer readable program code for generating stylesheets.

25. A computer system having at least one processing unit, at least one memory unit, and at least one display unit, said computer system further comprising:
means for selecting a target device or a device category or both;
means for designing a user interface; and
means for validating said user interface enabling a user to simulate display of user interface on a selected target device or a selected target category.

26. The computer system of claim 25 further comprising:
means for deploying said user interface to selected target devices or selected target categories.

27. The computer system of claim 25 further comprising means for customizing the user interface.
